(19) United States
(12) Patent Application Publication
(10) Pub. No.: US 2020/0180123 A1
(43) Pub. Date: Jun. 11, 2020

(54) NEGATIVE DRIVE ANGLE

(71) Applicant: Infastech Intellectual Properties Pte. Ltd., Singapore (SG)

(72) Inventors: Richard W. LUKES, Calmar, IA (US); Randy LUZUM, Calmar, IA (US); Mark THEISMANN, Decorah, IA (US); Doug OSBORN, Decorah, IA (US); Robert SMITH, Decorah, IA (US); Donald K. BLAESS, Cresco, IA (US)

(73) Assignee: Infastech Intellectual Properties Pte. Ltd, Singapore (SG)

(21) Appl. No.: 16/794,327

(22) Filed: Feb. 19, 2020

Related U.S. Application Data
(63) Continuation of application No. 13/590,421, filed on Aug. 21, 2012.
(60) Provisional application No. 61/527,606, filed on Aug. 25, 2011.

(51) Int. Cl. B25B 15/00; F16B 23/00

(52) U.S. Cl. CPC B25B 15/005; F16B 23/003

(57) ABSTRACT

A torque transmission driver has a main body having a first end portion adapted to receive and transmit torque from a torque generation source and a second end portion opposite the first end portion having a series of four, five or six lobes and troughs about a rotational axis, and a drive side transition between each lobe and trough on at least one side of each lobe forming a negative drive angle between −2° and −10°. A fastener corresponding to the torque transmission driver has a drive end portion adapted to engage the torque transmission driver and a lead end portion adapted to fasten the fastener, the drive end portion having a series of four, five or six lobes and troughs about a rotational axis, and a drive side transition between each lobe and trough on at least one side of each lobe forming a negative drive angle between −2° and −10°.

### CROSS-REFERENCE TO RELATED APPLICATION

This application is a continuation of and claims priority to and the benefit of U.S. patent application Ser. No. 13/590,421, filed on Aug. 21, 2012, which claims priority to U.S. Provisional Patent Application No. 61/527,606, filed on Aug. 25, 2011, the disclosure of these is incorporated herein by reference in their entirety.

### BACKGROUND AND SUMMARY

Fasteners and torque transmission drivers for torque transmitting systems are well-known in the art. The head of the fastener has a recess or a projection of a particular shape which fits a complimentary shaped projection or recess in the driver. One of the more commonly known torque transmitting systems is the cruciform type drive system commercialized as the PHILLIPS® drive system. See for example, U.S. Pat. No. 2,046,837. Numerous forms and shapes of torque transmitting drive systems have been proposed. See for example, U.S. Pat. No. 2,397,216.

Spline-type torque transmitting systems of five-lobe and six-lobe configurations have also been well-known. Examples of these five-lobe and six-lobe torque transmitting systems, with their fasteners and drivers, are described in U.S. Pat. Nos. 2,969,250; 3,187,790; 3,584,667; 4,970,922 and 5,279,190. Early versions of such spline-type torque transmission drive systems had square corners, for which corresponding fastener recesses were difficult and expensive to make and resulted in stresses in the fastener and/or driver which lead to fatigue failure with repeated use. Later versions of these five and six lobe spline type torque drive systems had a plurality of opposite intersecting curved surfaces evenly positioned about the 360° circumference of the fastener head or driver bit to form an alternating series of lobes and flutes. These latter torque drive systems overcame some of the problems inherent in the earliest spline type systems, but were not generally capable of retaining a lobe drive angle less than five degrees. Upon application of higher torques, force components would rise causing failure or strip out of the lobes from the fasteners or the drivers. One version of these later spline type torque drive systems, known commercially as the TORX® drive system, had six-lobe and five-lobe configurations based on mating arcuate surfaces designed to attain drive angles within the range of 10° to 20°, an outline of the prior TORX® six-lobe is shown in FIGS. 7 and 8 by curve 205. See U.S. Pat. No. 3,584,667.

A later version of this spline type torque transmission drive system reduced the drive angle to zero by having both the driven surfaces of the fastener head and the drive surfaces of the torque driver formed by a first series of elliptically curved surfaces with a second series of elliptically curved surfaces alternating there between. One series of these elliptically curved surfaces was convex, while the alternating series of elliptically curved surfaces was concave. The alternating concave and convex elliptically curved surfaces merged smoothly and tangentially to define a series of alternating flutes and lobes extending about the 360° circumference of the fastener head or the driver bit. Both the lobes and the flutes of the fastener head and driver bit were elliptically curved in section. Also, the centers of the elliptically curved lobes and corresponding centers of the elliptically curved flutes were disposed at the apexes of a regular hexagon, although not the same hexagon, due to the alternating nature of these components. See U.S. Pat. No. 5,279,190. An embodiment of this lobular torque transmission drive system has been commercially marketed as TORX PLUS® drive systems. An outline of the prior TORX PLUS® six-lobe driver is shown in FIGS. 7 and 8 by curve 203 with a mating TORX PLUS® fastener recess shown by curve 204.

The difficulty with these latter six-lobe spline-type systems is that there was a narrow point contact between the driver bit and the fastener head at each lobe when the fastener is torqued, and this point contact would change with wear of the torsion driver. This is seen by curves 203 and 204 shown in FIGS. 7 and 8 and described in more detail. With the zero drive angle illustrated by curves 203 and 204 in FIGS. 7 and 8, there was less movement of the contact point between the torque driver and fastener head with wear on the bit of the torque driver, but the lobes of the drive bit were still subject to shear and failure with wear. Additionally, the prior spline-type systems were less effective with thread forming and thread cutting fasteners because the drivers tended to cam out of the fastener, and the drivers wobbled in the fasteners not maintaining axial alignment. All of these problems were accentuated in extremely small size fastener heads and torsion drivers, particularly a small fastener having a major thread diameter less than about 0.039 inch (1.0 millimeter), or alternatively having a major thread diameter less than about 0.063 inch (1.6 millimeter), which tended to deform when in use because of the sizes of the lobes and the clearance tolerances involved.

What has continued to be needed is a torsion transmitting system with a fastener head and a torsion driver that remains stable with wear and enable the torque drive to transmit high torque to the head of the fastener with reduced shearing or breaking of the lobes of the driver or fastener. Moreover, needed is a five-lobe or six-lobe torsion transmitting system that would allow higher torques to be applied to fasteners by the torsion transmitting system. These problems were particularly accentuated in small size torque transmission systems where the lobes of both the fastener head and the driver bit were extremely small and the sizes of the lobes and the clearance tolerances corresponding small.

A fastener is disclosed for use in a torque transmitting system comprising: a fastener having a drive end portion and a lead end portion, the drive end portion adapted to engage a torque transmission driver and the lead portion adapted to thread the fastener, the drive end portion configured with drive surfaces comprising a series of five or six lobes and troughs about a rotational axis, and a drive side transition between each lobe and trough on at least one side of each lobe forming a negative drive angle between −2° and −10°. The drive side is the side of each lobe of the fastener from which torsion is applied to the drive end portion of a fastener by a torsion transmission driver in threading the fastener into a substrate as desired. Alternatively, the drive side transition may form a negative drive angle between −3 to −10.

The drive side transition of each lobe of the drive end portion of the fastener may be a negative drive angle between −4° and −6°.

The drive side transition of each lobe of the drive end portion of the fastener forming the negative drive angle has between 0.001 inch in length, such as for small fasteners having a major thread diameter less than about 0.039 inch (1.0 millimeter), and 0.020 inch in length, such as for fasteners having a major thread diameter less than about 0.12 inch (3.0 millimeter), along the lobe. Alternatively or in addition, the drive side transition of each lobe of the fastener may have a negative drive angle with a length along the lobe of the fastener between 20 and 40% of difference between the A and B radii, where A is the outer radius of a lobe and B is inner radius of a trough.

The drive end portion of the fastener may have an externally configured drive surface adapted to engage a torque transmission driver or an internally configured drive surface adapted to engage a torque transmission driver. In either case, the clearance between the drive end portion of the fastener and a bit of the torque transmission driver may be less than 0.002 inch.

Also disclosed is a torque transmission driver comprising: a main body having a first end portion and a second end portion, the first end portion adapted to receive and transmit torque from a torque generation source, the second end portion opposite the first end portion comprising a series of five or six lobes and troughs about a rotational axis, and a drive side transition between each lobe and trough on at least one side of each lobe forming a negative drive angle between −2° and −10°. The drive side is the side of each lobe of the torque transmission driver from which torsion is applied to a drive end portion of a fastener by the torsion driver in threading the fastener into a substrate as desired.

The drive side transition of each lobe of the second end portion of the torque transmission driver may be a negative drive angle between −4° and −6°.

The drive side transition of each lobe of the second end portion of the torque transmission driver may have negative drive angle has between 0.001 and 0.020 inch in length along the lobe, depending on the size of the fastener and the torsion driver. Alternatively or in addition, the drive side transition of each lobe of the second end portion of the torque transmission driver may have a negative drive angle with a length along the lobe and trough between 20 and 40% of difference between the radii A and B, where A is the outer radius of the lobe and B is inner radius of the trough.

The second end portion of the torque transmission driver fastener may have an externally configured drive surface adapted to engage a fastener or an internally configured drive surface adapted to engage a fastener. In either case, the clearance between the second end portion of a bit of the torque transmission driver and a drive portion of a fastener may be less than 0.002.

Other details, objects and advantages of the present torques transmitting system and fasters and torsion drivers thereof will be apparent as the following description of embodiments of the invention proceeds.

### BRIEF DESCRIPTION OF THE DRAWINGS

The drawings illustrate specific embodiments of the torque transmission system of the present invention with its fasteners and torsion drivers in which:

FIG. 1 is a fragmentary isometric view of a six-lobe fastener and a partial bit of the torsion driver illustrating an embodiment of the present invention,

FIG. 2 is an elevational view of a six-lobe bit of a torque transmission driver and fragmentary view of a six-lobe fastener shown in cross-section illustrating an embodiment of the present invention,

FIG. 3A is a cross-sectional view showing the engagement of a six-lobe torsion driver with a recess in a six-lobe fastener head illustrating an embodiment of the present invention,

FIG. 3B is a detail of the cross-sectional view of the driver bit of FIG. 3A showing lobe of a six-lobe torsion driver,

FIG. 3C is a detail of the cross-sectional view of the fastener recess of FIG. 3A showing lobe of a six-lobe fastener recess,

FIG. 4 is an isometric view of a part of a fastener with a projected fastener head and a partial bit of the torsion driver illustrating an alternative embodiment of the present invention,

FIG. 5 is an elevational view of a bit for a torsion driver in relation to a partial cross-sectional view of the fastener with a protruded head illustrating an alternative embodiment of the present invention,

FIG. 6A is a cross-sectional view illustrating engagement of six-lobe torsion driver with a projecting head of a fastener illustrating an alternative embodiment of the present invention,

FIG. 6B is a detail of the cross-sectional view of the driver bit of FIG. 6A showing lobe of a six-lobe torsion driver,

FIG. 6C is a detail of the cross-sectional view of the fastener recess of FIG. 6A showing lobe of a six-lobe fastener recess,

FIG. 7 is an alternative cross-sectional view through a five-lobe torsion driver illustrating an embodiment of the present invention,

FIG. 8 is another alternative cross-sectional view through a four-lobe torsion driver illustrating an embodiment of the present invention,

FIG. 9 is an outline illustrating the configuration of the six-lobe fastener head and six-lobe torsion driver of the present invention as well as a prior art six-lobe torsion drivers and six-lobe fastener heads for comparison, and

FIG. 10 is an enlarged view of a portion of FIG. 9 identified as detail 10 in FIG. 9.

### DETAILED DESCRIPTION OF THE DRAWINGS

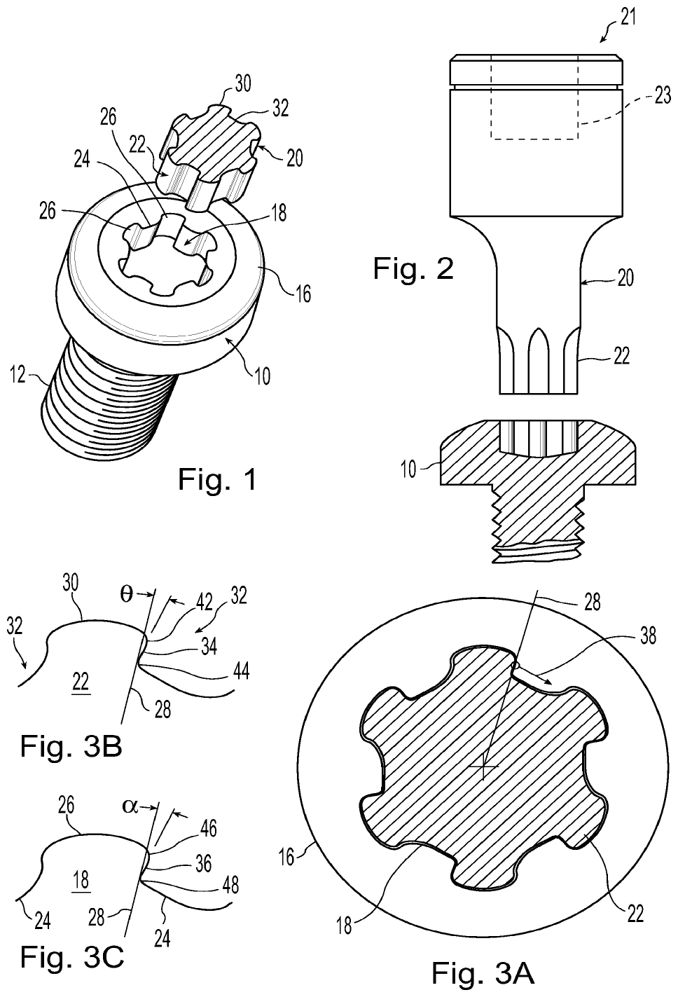

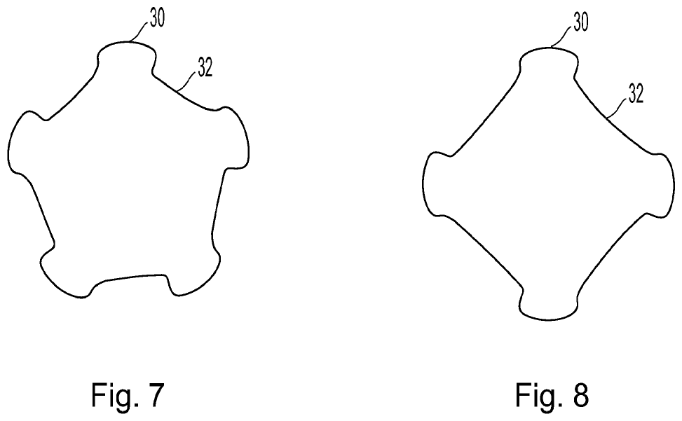

Referring to FIGS. 1 and 2, there is illustrated a fastener 10 and a torsion driver 20 of a six lobe torque transmission system. The fastener 10 has a shank having threads forming a lead portion 12 of the fastener 10 adapted to thread the fastener 10 into a substrate as desired. The fastener 10 also has a head portion 16 having internally configured drive surfaces forming a six-lobe recess 18, or alternatively, a five-lobe recess, illustrated by way of the example cross-section in FIG. 7, adapted to mate with a correspondingly configured bit portion 22 of the torsion driver 20 that is adapted to transmit torque driving forces to the fastener 10. The recess 18 of fastener 10 is configured with a series of alternating lobes 24 and troughs 26 positioned around the 360° circumference of recess 18. Correspondingly, bit portion 22 of torsion driver 20 has drive surfaces forming alternating lobes 30 and troughs 32 positioned around the 360° circumference forming six alternating lobes 30 and troughs 32, complementing the shape of the lobes 24 and troughs 26 of the recess 18 of the fastener head 16.

The bit portion 22 of the torsion driver 20 may have a flat end surface as shown in FIG. 2. Alternatively, the bit portion 22 may have a protruding lead end such as disclosed in the international application serial number PCT/US2011/043198, filed Jul. 7, 2011, titled Torque Transmission Driver. The driver 20 includes an end portion 21 adapted to receive and transmit torque from a torque generation source, such as a power driver, manually operated driver handle, drill motor, or other torque generation source as desired. The end portion 21 may include a recess 23, such as shown in dashed line in FIG. 2, for engaging the torque generation source. Alternatively, the end portion 21 may be in the form of a projection or shank (not shown) adapted to receive and transmit torque from a torque generation source.

Referring to FIG. 3A, the bit portion 22 of torsion driver 20 is shown assembled into the recess 18 of the head portion 16 of fastener 10 with lobes 30 and trough 32 of bit portion 22 of torsion driver 20 engaging the troughs 26 and the lobes 24 of the recess 18 in fastener head 16, respectively. As shown in FIGS. 3A and 3B, between each of the lobes 30 and trough 32 of the bit portion 22 of torsion driver 20 is provided a drive side transition 34 forming a negative drive angle θ between −2 and −10° extending between an outer transition radius 42 and an inner transition radius 44. The drive angle θ is measured between the drive side transition 34 and a radial line 28 extending from the rotational axis and tangent to the inner transition radius 44 as shown in FIG. 3B. As shown in FIG. 3C, between each lobe 24 and trough 26 of recess 18 of fastener head 16 of fastener 10 is provided a drive side transition 36 forming a negative drive angle α between −2 and −10° extending between an outer transition radius 46 and an inner transition radius 48. The drive angle θ is measured between the drive side transition 36 and a radial line 28′ extending from the rotational axis and tangent to the inner transition radius 48 as shown in FIG. 3C. The drive side transition 34 in bit portion 22 and the drive side transition 36 in recess 18 of fastener head 16 both may have a negative angle between −3 and −10°. In yet another alternative, the drive side transition 34 in bit portion 22 and the drive side transition 36 in recess 18 of fastener head 16 both may have a negative angle between −4 and −6°. With this configuration, the clearance between the drive side transition 34 of the bit portion 22 of the torsion driver 20 and the drive side transition 36 of recess 18 in the fastener head 16 may be maintained less than 0.002 inch. This tolerance provides for effective and extended use of the torsion driver 20 with fasteners 10. Typically, the fastener drive angle α is approximately the same as the bit drive angle θ to provide surface to surface contact. Alternatively, the fastener drive angle α may be greater or less than the bit drive angle θ to accommodate clearances between the fastener and the driver.

In any case, the drive side transitions 34 of the bit portion 22 and the drive side transition 36 in recess 18 of the fastener head 16 engage when torsion forces 38 are applied to the head portion 16 of fastener 10 through bit portion 22 by rotation of the torsion driver 20. Both the driver side transition 34 of the bit portion 22 and the driver side transition 36 of recess 18 of fastener head 16 provide an engagement length between each of the lobes and troughs of the bit portion 22 of the torsion driver 20 and the recess 18 in the fastener head 16 ranging from 20 to 40% of the difference between radii A and B, where A is the outer radius of the lobe of the bit portion 22 for recess 18 and radius B is the inner radius of the trough of bit portion 22 of recess 18. The actual length of the drive side transition 34 or 36 may be between 0.001 and 0.020 inch in length depending on the size of the fastener 10 and torsion driver 20. For example, the length of the drive side transition may be between 0.001 inch and about 0.005 inch for small fasteners having a major thread diameter less than about 0.039 inch (1.0 millimeter). That distance may be in larger fasteners, for example, between about 0.005 and about 0.015 in length for fasteners having a major thread diameter between about 0.039 inch (1.0 millimeter) and 0.12 inch (3.0 millimeter), and will proportionately be scaled upwardly and downwardly in length as the size of the fastener 10 and the torsion driver 20 increase and decrease respectively. The drive side transition 34 of the torsion driver 20 and drive side transition 36 of recess 18 of the fastener head 16 allow for spreading the torsion forces when tightening of the fastener 10 and with a component of torsion forces inwardly as shown by arrow 38 in FIG. 3A. Moreover, these torsion forces 38 exerted by the bit portion 22 of the torsion driver 20 on the fastener head 16 and the fastener through recess 18 remain relatively stable with wear of the bit portion 22 of torsion driver 20.

The recess 18 of the fastener head 16 and the correspondingly configured bit portion 22 of the torsion driver 20 are configured for the bit portion 22 to be inserted into the recess 18 a depth sufficient to permit good application of torque from the driver bit to the fastener. For example, a small fastener having a major thread diameter less than about 0.039 inch (1.0 millimeter) may have an effective engagement depth of the drive surfaces of less than 0.010 inch (0.25 millimeter). For larger fasteners, such as having a major thread diameter greater than about 0.236 inch (6.0 millimeter), the effective engagement depth may be 0.06 inch (1.5 millimeter), or greater.

It should be noted that similar drive side transitions may be provided between the lobes and troughs for loosening of fasteners by application of torsion forces through the torsion driver. This added feature may be useful for fasteners designed to be unfastened for disassembly. In applications for disassembly, the drive side transition may include a drive angle forming a positive drive angle or a negative drive angle as desired. However, that would be only a fraction of the applications, since most fasteners are tightened and positioned for use during the useful life of the assembly in which they are fastened. In addition, the drive side transitions are provided for disassembly and care must be taken to ensure that the lobes of the transition driver are not weakened, limiting the useful life of them.

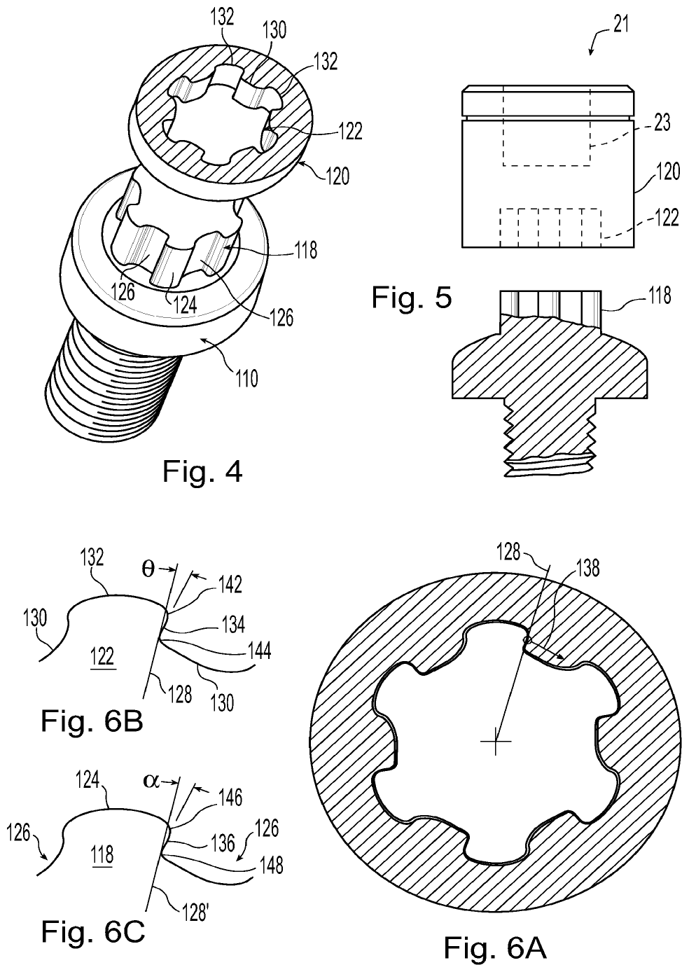

Referring to FIGS. 4 and 5, a fastener 110 and torsion driver 120 of the six lobe torsion transmission system is illustrated in which the fastener 110 has an externally configured driving surfaces 118 configured in the form of a series of alternating lobes 124 and troughs 126 positioned around the 360° circumference of the external surfaces 118. Correspondingly, bit portion 122 of torsion driver 120 has alternating lobes 130 and troughs 132 positioned around the 360° circumference forming six alternating lobes 130 and troughs 132, complementing the shape of the lobes 124 and troughs 126 of the external surfaces 118 of the fastener head 116 of fastener 110.

Referring to FIG. 6A, the bit portion 122 of torsion driver 120 is shown assembled over the external drive surfaces 118 of the head portion 116 of fastener 110, with lobes 130 and troughs 132 of bit portion 122 of torsion driver 120 engaging the troughs 128 and lobes 126 of the external surfaces 118 of fastener head 116, respectively. As shown in FIG. 6A and 6B, between each of the lobes 130 and troughs 132 of the bit portion 122 of the torsion driver 120 is provided a drive side transition 134 forming the negative drive angle θ between −2 and −10° extending between an outer transition radius 142 and an inner transition radius 144. The drive angle θ is measured between the drive side transition 134 and a radial line 128 extending from the rotational axis and tangent to the inner transition radius 144 as shown in FIG. 6B. As shown in FIG. 6C, between each lobe 124 and trough 126 of external surfaces 118 of the fastener head 116 of the fastener 110 is provided a drive side transition 136 forming the negative drive angle α between −2 and −10° extending between an outer transition radius 146 and an inner transition radius 148. The drive angle α is measured between the drive side transition 36 and a radial line 128′ extending from the rotational axis and tangent to the inner transition radius 148 as shown in FIG. 6C. The drive side transition 134 in bit portion 122 and the drive side transition 136 in recess 118 both may have a negative angle between −3 and −10°. In yet another alternative, the drive side transition 134 of bit portion 122 and the drive side transition 136 in external surfaces 118 of fastener head 116 both may have a negative drive angle between −4 and −6°. Again, with this configuration, the clearance between the drive side transition 134 of bit portion 122 of the torsion drive 120 and the drive side transition 136 of external surfaces 118 of the fastener head 116 may be maintained less than 0.002 inch. This tolerance provides for effective and extended use of the torque driver 120 with multiple fasteners 110.

The drive side transitions 134 of the bit portion 122 and the drive side transition 136 in external surfaces 118 of the fastener head 116 engage when the torsion forces 138 are provided to the head portion 116 of fastener 110 by torsion driver 120 through bit portion 122. Both the drive transition 134 of the bit portion 122 and the drive side transition 136 of external surfaces 118 of fastener head 116 provide an engagement length between each of the lobes and troughs of the bit portion 122 of the transmission driver 120 and the external drive surfaces 118 of the fastener head 116 ranging from 20 to 40% of the distance between radii A and B, where A is the outer radius of the lobe of the bit portion 122 of external surfaces 118 and radius B is the inner radius of the trough of the bit portion 122 of external surfaces 118. The actual length of the drive side transition 134 or 136 may be between 0.001 and 0.020 inch in length depending on the size of the fastener 110 and the torsion driver 120. For example, the length of the drive side transition may be between 0.001 inch and about 0.005 inch for fasteners having a major thread diameter less than about 0.039 inch (1.0 millimeter). That distance may be in larger fasteners, for example, between about 0.005 and about 0.015 in length for fastener sizes for fasteners having a major thread diameter between about 0.039 inch (1.0 millimeter) and 0.12 inch (3.0 millimeter), and will be proportionately scaled up or down in length as the size of the fastener 110 and the torsion driver 120 increases or decreases respectively. The drive side transition 134 of the transition driver 120 and the drive side transition 136 of external surfaces 118 of the fastener head 116 allow for spreading of the torque forces when tightening of the fastener 110 and with a component of transmission forces inwardly as shown by arrow 138 in FIG. 6. However, these torsion forces 138 exerted by the bit portion 122 of the torsion driver 120 on the fastener head 116 and the fastener through external surfaces 118 remain relatively stable with wear of the bit portion 122 of the driver 120.

The external drive surfaces 118 of the fastener head 116 and the correspondingly configured bit portion 122 of the torsion driver 120 are configured for the external drive surfaces 118 to be inserted into corresponding surfaces in the bit portion 122 a depth sufficient to permit good application of torque from the driver bit to the fastener. For example, a small fastener having a major thread diameter about 0.039 inch (1.0 millimeter) may have an effective depth engagement of the external drive surfaces into the bit recess of less than 0.010 inch (0.25 millimeter). For larger fasteners, such as having a major thread diameter greater than about 0.236 inch (6.0 millimeter), the effective depth engagement may be 0.06 inch (1.5 millimeter), or greater.

Again, as with the embodiment illustrated in FIGS. 1, 2 and 3 with the fastener having internally configured drive surfaces shown by recess 18, the present embodiment shown in FIGS. 4, 5 and 6 with externally configured drive surfaces on the fastener may be provided with additional similar drive side transitions between the lobes and the troughs for loosening of the fasteners by application of torsion forces through the torsion driver. As with the embodiment shown in FIGS. 1, 2 and 3, this added feature may be useful for fasteners embodied as shown in FIGS. 4, 5 and 6 to be unfastened for disassembly, and may have a positive or negative drive angle. However, as with the embodiment shown in FIGS. 1, 2 and 3, there is likely to be only a fraction of the applications because most fasteners are tightened and positioned for use during the useful life of the assembly for which they are used. In addition, as with the embodiment shown in FIGS. 1, 2 and 3, the present embodiment of the invention with drive side transitions for unfastening may be done with care to avoid weakening of the lobes of the transition driver inhibiting the useful life of the driver.

It is contemplated that the fasteners 10, 110 and drivers 20, 120 of the present torque transmission system may include a five-lobe torque transmission system shown by example of the cross-section in FIG. 7, or may be a four-lobe torque transmission system shown by example of the cross-section in FIG. 8. In one application, a small fastener having a major thread diameter less than about 0.039 inch (1.0 millimeter) may utilize a four-lobe torque transmission system.

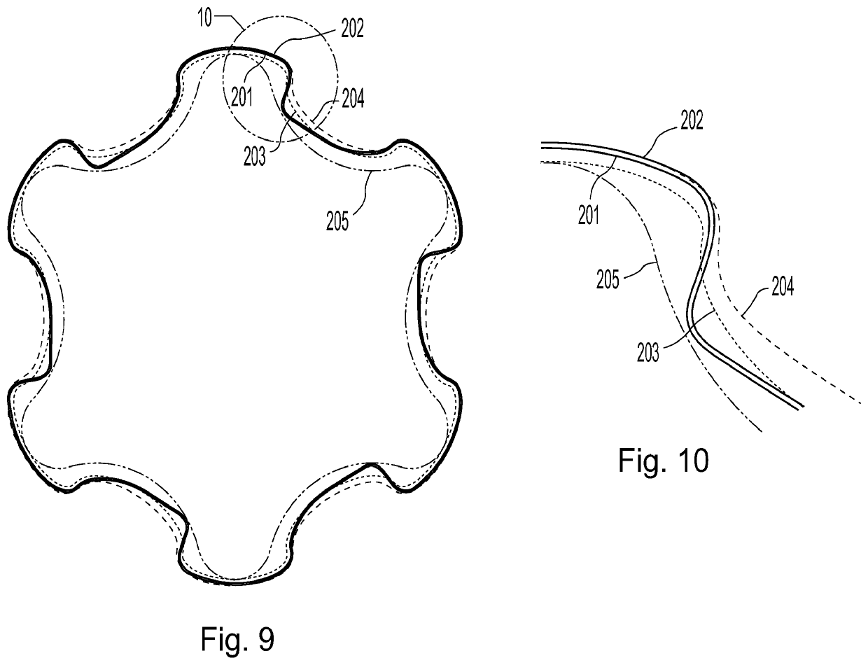

Referring to FIGS. 9 AND 10, it is illustrated in the outline of the six-lobe torsion driver and the recess of the fastener similar to that shown in FIGS. 1, 2 and 3 by curves 201 and 202. It is also shown by curves 203 and 204 is a prior spline type six lobe fastener and torsion driver of the type described in U.S. Pat. No. 5,279,190 and commercialized as the TORX PLUS® Drive System. Also shown as a curve 205 is a prior spline type six-lobe torque driver and fastener as described in U.S. Pat. No. 3,584,667 and commercialized as the TORX® Drive System. As can be seen from FIGS. 7 and 8, the present drive system provides for much closer clearances between the bit portion of the torsion driver and the configuration in the head portion of the fastener, providing for much more rapid and higher torsions applied to the fastener by the system. Further, FIGS. 7 and 8 illustrate that the torsion driver of the present system can be utilized to tighten six lobe fasteners of the TORX® and the TORX PLUS® drive systems; however, six lobe drivers of the TORX PLUS® spline type torsion drive systems may not be used with the torsion drive system of the present invention.

The present torque transmission drivers may be steel or aluminum as desired for the application. In one alternative, the steel is a medium carbon steel, such as AISI S2, 6150, 8650, 8660, or other tool steel compositions or alloy steel compositions as desired for hardenability and strength. The medium carbon steel may be hardened after the driver is made. After the torque transmission driver is formed, the steel driver may be hardened to a hardness of 58-62 HRC. Alternatively, the steel driver may be hardened to a hardness greater than 52 HRC.

While certain embodiments have been described, it must be understood that various changes may be made and equivalents may be substituted without departing from the spirit or scope of the present disclosure. In addition, many modifications may be made to adapt a particular situation or material to the teachings of the disclosure without departing from its spirit or scope.

What is claimed is:

1. A fastener for use in a torque transmitting system comprising:
a drive end portion and a lead end portion, the drive end portion adapted to engage a torque transmission driver and the lead end portion adapted to fasten the fastener,
the drive end portion comprising a series of four, five or six lobes and troughs about a rotational axis, wherein each lobe is smoothly formed, and
a drive side transition between each lobe and trough on one side of each lobe,
wherein the drive side transition of each lobe has a length between the lobe and a trough ranging from 20% and 40% of the difference between radii A and B from a rotational center, where A is a radius of a lobe and B is a radius of a trough, and
wherein the drive side transition forms a negative drive angle between −2° and −10°.

2. The fastener as claimed in claim 1, wherein the drive side transition of each lobe has a negative drive angle between −4° and −6°.

3. The fastener as claimed in claim 1, wherein the drive end portion of the fastener is formed convexly and has drive surfaces externally configured on the convex portion to engage a torque transmission driver.

4. The fastener as claimed in claim 3, wherein clearance between the drive end portion of the fastener and the torque transmission driver is less than 0.002 inch.

5. The fastener as claimed in claim 1, wherein the drive end portion of the fastener is formed concavely and has drive surfaces internally configured on the concave portion to engage a torque transmission driver.

6. The fastener as claimed in claim 5, wherein clearance between the drive end portion of the fastener and the torque transmission driver is less than 0.002 inch.

7. The fastener claimed in claim 1, wherein the fastener has a major thread diameter less than 0.039 inch (1.0 millimeter).

8. The fastener as claimed in claim 1, where the drive side transition of each lobe with said negative drive angle has a length between 0.001 and 0.020 inch along the lobe of the fastener.

9. A toque transmission driver comprising:
a main body having a first end portion and a second end portion,
the driver first end portion adapted to receive and transmit torque from a torque generation source;
the driver second end portion opposite the driver first end portion comprising a series of four, five or six driver lobes and driver troughs about a rotational axis, wherein each driver lobe is smoothly formed, and
a drive side transition extending between each driver lobe and driver trough on one side of each driver lobe, and
wherein the drive side transition of each driver lobe with said negative drive angle
has a length along the driver lobe between 20% and 40% of the difference between radii A and B from a rotational center, where A is a radius of a driver lobe and B is a radius of a driver trough, and
wherein the drive side transition forms a negative drive angle between −2° and −10°.

10. The torque transmission driver as claimed in claim 9, wherein the drive side transition of each driver lobe has a negative drive angle between −4° and −6°.

11. The torque transmission driver as claimed in claim 9, wherein the driver second end portion is formed convexly and has drive surfaces externally configured on the convex portion to engage a fastener.

12. The torque transmission driver as claimed in claim 11, wherein clearance between the driver second end portion and fastener is less than 0.002 inch.

13. The torque transmission driver as claimed in claim 9, wherein the driver second end portion is formed concavely and has drive surfaces internally configured on the concave portion to engage a fastener.

14. The torque transmission driver as claimed in claim 13, wherein clearance between the driver second end portion and the fastener is less than 0.002 inch.

15. The torque transmission driver as claimed in claim 9, where the driver second end portion is adapted to engage a fastener having a major thread diameter less than 0.039 inch (1.0 millimeter).

16. The torque transmission driver as claimed in claim 9, where the driver second end portion is adapted to engage a fastener having a major thread diameter less than 0.063 inch (1.6 millimeter).

17. The torque transmission driver as claimed in claim 9, wherein the drive side transition of each driver lobe with said negative drive angle has a length between 0.001 and 0.020 inch along the driver lobe.
